(19) United States
(12) Patent Application Publication
(10) Pub. No.: US 2015/0040011 A1
(43) Pub. Date: Feb. 5, 2015

(54) VIDEO CONTENT DISPLAYING SCHEMES

(71) Applicant: KT Corporation, Seongnam-si (KR)

(72) Inventor: Wang-sung CHUN, Anyang-si (KR)

(21) Appl. No.: 14/446,585

(22) Filed: Jul. 30, 2014

(30) Foreign Application Priority Data
Jul. 30, 2013 (KR) 10-2013-0090315

(51) Int. Cl. G06F 3/0484; G06F 3/0482

(52) U.S. Cl. CPC G06F 3/04842; G06F 3/0482
USPC 715/723

(57) ABSTRACT

In one example embodiment, a method performed under control of an apparatus includes dividing video content into a plurality of sections; selecting a plurality of candidate thumbnail images in each of the sections; transmitting, to a plurality of end devices, the plurality of candidate thumbnail images serially, along with the video content; receiving, from the plurality of end devices, user input to select various ones of the plurality of candidate thumbnail images; and changing a display time period of the plurality of candidate thumbnail images, based on the received user input.

### TECHNICAL FIELD

The embodiments described herein pertain generally to video content displaying schemes.

### BACKGROUND

A thumbnail image may be implemented for summarizing, browsing, or searching the video content. The thumbnail image may provide information to a user using a still image instead of a moving image. The thumbnail image may be generated as a key frame for video indexing or may be a representative image that serves as a preview or digest for a program in a program guide.

### SUMMARY

In one example embodiment, a method performed under control of an apparatus may include dividing video content into a plurality of sections; selecting a plurality of candidate thumbnail images in each of the sections; transmitting, to a plurality of end devices, the plurality of candidate thumbnail images serially, along with the video content; receiving, from the plurality of end devices, user input to select various ones of the plurality of candidate thumbnail images; and changing a display time period of the plurality of candidate thumbnail images, based on the received user input.

In another example embodiment, an apparatus may include a video divider configured to divide video content into a plurality of sections; a candidate thumbnail manager configured to determine a plurality of candidate thumbnail images in each of the sections; a transmitter configured to transmit, to a plurality of end devices, the plurality of candidate thumbnail images serially, along with the video content; a receiver configured to receive, from the plurality of end devices, user input to select various ones of the plurality of candidate thumbnail images; and a representative thumbnail manager configured to identify a representative thumbnail image in each of the sections from among the plurality of candidate thumbnail images, based on the user input.

In yet another example embodiment, a system may include: a video playing device configured to: play video content; display serially, a plurality of candidate thumbnail images in each of multiple sections that constitutes the video content; and transmit user input to select at least one candidate thumbnail image from among the plurality of candidate thumbnail images. The system may also include: a video manager configured to: divide the video content into the multiple sections; select the plurality of candidate thumbnail images in each of the multiple sections; transmit, to the video playing device, the plurality of candidate thumbnail images serially, along with the video content; and change a display time period of the plurality of candidate thumbnail images, based on the user input.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent from the following detailed description. The use of the same reference numbers in different figures indicates similar or identical items.

FIG. 1 shows an example system in which schemes for displaying video content may be implemented, in accordance with various embodiments described herein;

FIGS. 2A and 2B show illustrative example video content database of an apparatus by which at least portions of schemes for displaying video content may be implemented, in accordance with various embodiments described herein;

FIG. 3 shows an illustrative example of video content transmitted by an apparatus by which at least portions of schemes for displaying video content may be implemented, in accordance with various embodiments described herein;

FIG. 4 shows an illustrative example of an application by which at least portions of schemes for displaying video content may be implemented, in accordance with various embodiments described herein;

FIG. 5 shows an example apparatus by which at least portions of schemes for displaying video content may be implemented, in accordance with various embodiments described herein;

FIG. 6 shows an example processing flow of operations by which at least portions of schemes for displaying video content may be implemented, in accordance with various embodiments described herein; and

FIG. 7 shows an illustrative computing embodiment, in which any of the processes and sub-processes of schemes for displaying video content may be implemented as computer-readable instructions stored on a computer-readable medium, in accordance with various embodiments described herein.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

In some examples, a user may request video content from a content provider. The video content and representative thumbnail image in each section of the video content may be reproduced or displayed on an end device of the user. The representative thumbnail image in each section of the video content may be previously identified by a server or an apparatus that may be configured to provide the video content based on multiple user selection inputs or user's feedbacks which are made by other people. For example, a thumbnail image to which the most selections are made may be identified as a representative thumbnail image of a section of the video content. Thus, the most preferred or famous thumbnail images (e.g., representative thumbnail images) in each section of the video content may be provided to users.

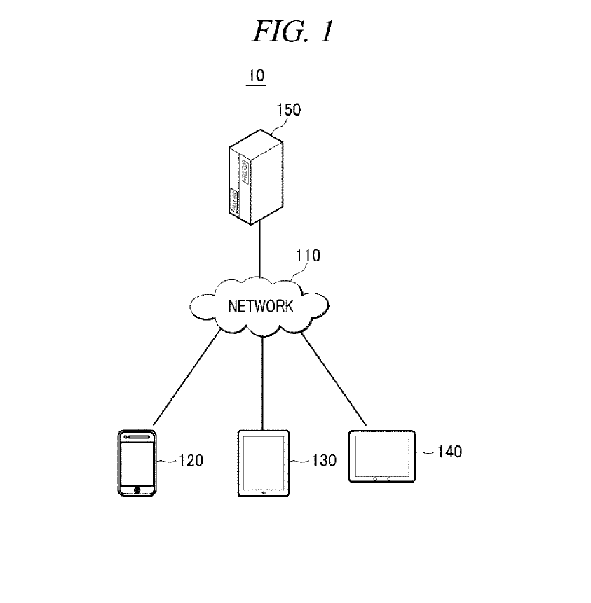

FIG. 1 shows an example system 10 in which schemes for displaying video content may be implemented, in accordance with various embodiments described herein. As depicted in FIG. 1, system configuration 10 may include, at least, a first end device 120, a second end device 130, a third end device 140, and an apparatus 150. At least two or more respective embodiments of first end device 120, second end device 130, third end device 140, and apparatus 150 may be communicatively connected to each other via a network 110.

Network 110 may include, as non-limiting examples, wireless networks such as a mobile radio communication network including at least one of a 3rd generation (3G), 4^{th} generation (4G), or 5^{th} (5G) mobile telecommunications network, various other mobile telecommunications networks, a satellite network, WiBro (Wireless Broadband Internet), Mobile WiMAX (World Interoperability for Microwave Access), HSDPA (High Speed Downlink Packet Access), or the like.

In some embodiments, for example, a respective one of first end device 120, second end device 130, and third end device 140 may be a device capable of playing video content thereon. As non-limiting examples, the respective one of first end device 120, second end device 130, and third end device 140 may refer to a notebook computer, a personal computer, a smart phone, a smart television, a digital camera, a tablet computer, a phablet device, or a personal communication terminal, such as PCS (Personal Communication System), GMS (Global System for Mobile communications), PDC (Personal Digital Cellular), PDA (Personal Digital Assistant), IMT (International Mobile Telecommunication)-2000, CDMA (Code Division Multiple Access)-2000, W-CDMA (W-Code Division Multiple Access) and Wibro terminal.

Apparatus 150 may refer to one or more servers, processing apparatuses or computing devices hosted and/or supported by a service provider that provides video content to multiple end devices, including first end device 120, second end device 130 and/or third end device 140. In some embodiments, apparatus 150 may be one of multiple hosted servers, processing apparatuses, or computing devices that may be configured to divide video content into multiple sections; determine a representative thumbnail image corresponding to each of the sections; and transmit, to multiple end devices, including first end device 120, second end device 130 and/or third end device 140, the video content and the determined representative thumbnail image. As referenced herein, a thumbnail image may be an image or frame of the video content that is stored in a database. For example, apparatus 150 may be configured to identify or recognize all images or frames that may constitute the video content using known image or frame recognition technologies, and to store the identified or recognized images or frames in the database.

Apparatus 150 may be configured to divide video content into multiple sections. As referenced herein, a section of the video content may refer to a part of the video content, which may have one or more frames to be reproduced on multiple end devices. In some embodiments, apparatus 150 may be configured to divide the video content into the multiple sections, based on at least one of pixel data or audio data of the frames that are included in each of the multiple sections, automatically using known image analysis technologies or audio analysis/recognition technologies. Thus, multiple thumbnail images in each of the multiple sections of video may be identified, as a preliminary step before providing the multiple thumbnail images to end devices.

For example, apparatus 150 may analyze and/or obtain RGB values in each frame (e.g., from first frame to sixth frame) of the video content automatically using known image analysis technologies so as to identify multiple sections of the video content. Further, apparatus 150 may identify or determine the first frame, second frame and third frame as a first section of the video content, and may identify or determine the fourth frame, fifth frame and sixth frame as a second section of the video content, if a difference between the RGB value of the third frame and the RGB value of the fourth frame is greater than a predetermined threshold value.

For another example, apparatus 150 may analyze and/or obtain audio files that may be included in each frame (e.g., from first frame to sixth frame) of the video content automatically using known audio analysis technologies or audio recognition technologies so as to identify multiple sections of the video content. Further, apparatus 150 may identify or determine the first frame, second frame and third frame as a first section of the video content and the fourth frame, fifth frame and sixth frame as a second section of the video content, if a difference between a magnitude or a tone that corresponds to the third frame and a magnitude or a tone that corresponds to the fourth frame is greater than a predetermined threshold value.

In some embodiments, apparatus 150 may be configured to divide the video content into the multiple sections, based on a playing time of each section automatically using known image or frame recognition technologies so as to determine a time length for each section of the video content. For example, the video content may be divided into multiple sections of equal or substantially equal time length.

Apparatus 150 may be further configured to select multiple candidate thumbnail images in each of the sections. As referenced herein, a thumbnail image may be an image or frame of the video content that are stored in a database. For example, apparatus 150 may be configured to identify or recognize all images or frames that may constitute the video content using known image or frame recognition technologies, and to store the identified or recognized images or frames in the database. Apparatus 150 may be further configured to determine and/or select one or more of the frames that are included in a section of the video content as the candidate thumbnail images of the section from the database. Further, each of the multiple candidate thumbnail images may have a display time period. As referenced herein, the display time period refers to a length of time, i.e., duration, for which a candidate thumbnail image to be displayed on an end device. For example, an initial display time period of each candidate thumbnail image may be the same.

For example, apparatus 150 may be configured to divide the video content into two sections (e.g., first section and second section). A total playing time of the video content may be twenty minutes, and apparatus 150 may divide the video content into two-ten minutes. Apparatus 150 may be further configured to determine and/or select two candidate thumbnail images (e.g., first candidate thumbnail image and second candidate thumbnail image) in each of the sections from a database that may store all images or frames that may constitute the video content automatically, so as to provide the candidate thumbnail images to end devices. The first candidate thumbnail image of the first section may be the first frame of the video content, the second candidate thumbnail image of the first section may be a frame after five minutes from the first frame of the video content, the first candidate thumbnail image of the second section may be a frame after ten minutes from the first frame of the video content, and the second candidate thumbnail image of the second section may be a frame after fifteen minutes from the first frame of the video content.

Apparatus 150 may be configured to receive, from one or more end devices (e.g., first end device 120, second end device 130, and third end device 140), a request for the video content. Apparatus 150 may be configured to transmit, to first end device 120, second end device 130, and third end device 140, the multiple candidate thumbnail images, along with the video content in response to the request. The video content and the multiple candidate thumbnail images may be displayed or reproduced on first end device 120, second end device 130, and third end device 140. In some embodiments, apparatus 150 may be configured to stream the video content and the multiple candidate thumbnail images to first end device 120, second end device 130, and third end device 140.

In some embodiments, apparatus 150 may be configured to transmit the multiple candidate thumbnail images of each section, serially to one or more of first end device 120, second device 130, and third end device 140. For example, apparatus 150 may be configured to transmit the first candidate thumbnail image of the first section of video content and the first candidate thumbnail image of the second section of video content for ten minutes, and thus, the first candidate thumbnail image of the first section of video content and the first candidate thumbnail image of the second section of video content may be displayed on one or more of first end device 120, second device 130, and third end device 140 for ten minutes. Apparatus 150 may transmit the second candidate thumbnail image of the first section and the second candidate thumbnail image of the second section ten minutes from the beginning of the transmission of the first candidate thumbnail image of the first section of video content and the first candidate thumbnail image of the second section of video content. Thus, the second candidate thumbnail image of the first section of video content and the second candidate thumbnail image of the second section of video content may be displayed on one or more of first end device 120, second device 130, and third end device 140 for ten minutes. That is, the multiple candidate thumbnail images of each section may be displayed, serially and/or alternatively, on first end device 120, second end device 130, and third end device 140 automatically. Thus, each of the candidate thumbnail images may be displayed for a period of ten minutes. Accordingly, the displayed candidate thumbnail images of respective section of video content may be changed at a predetermined time interval (i.e., at the time interval of the display time period of each candidate thumbnail image). The time length for which the first candidate thumbnail image of the first section of video content, the first candidate thumbnail image of the second section of video content, the second candidate thumbnail image of the first section of video content, and the second candidate thumbnail image of the second section of video content are transmitted and displayed is not limited to ten minutes. The time length may be set or determined automatically based on the number of candidate thumbnail images in each section of video content.

Apparatus 150 may be configured to receive, from the one or more end devices (e.g., first end device 120, second end device 130, and third end device 140), user input to select various ones of the multiple candidate thumbnail images. For example, apparatus 150 may be configured to receive, from first end device 120, first user input to select the first candidate thumbnail image of the first section of the video content. Apparatus 150 may be configured to then stream, to first end device 120, the first section of the video content, in which the selected first candidate thumbnail image is included. Further, apparatus 150 may be configured to receive, from second end device 130, second user input to select the first candidate thumbnail image of the second section of the video content. Apparatus 150 may be configured to then stream, to second end device 130, the second section of the video content, in which the selected first candidate thumbnail image is included.

Apparatus 150 may be configured to change the display time period of the multiple candidate thumbnail images, based on the received user input. For example, apparatus 150 may change the display time period of the multiple candidate thumbnail images, based on a number of times each of the multiple candidate thumbnail images is selected. For example, as a candidate thumbnail image is selected by multiple end devices more, the display time period of the candidate thumbnail image may increase. Inversely, as a selection of a candidate thumbnail image decreases, the display time period of the candidate thumbnail image may also decrease.

For another example, apparatus 150 may be configured to change the display time period of the multiple candidate thumbnail images, based on a number of times each of the sections has been played. The number may increase for a selected candidate thumbnail image of a section when the selected candidate thumbnail image causes the sections to be played for more than a predetermined amount of time. The predetermined amount of time may be determined based on a total playing time of each of the sections. For example, the predetermined amount of time may be half of a total playing time of each of the sections.

For example, the first section of video content may be displayed on first end device 120, since apparatus 150 streams, to first end device 120, the first section of the video content in which the selected first candidate thumbnail image is included when the first candidate thumbnail image of the first section is selected by first end device 120. Apparatus 150 may be configured to receive, from first end device 120, information regarding an amount of time for which the first section of the video content is reproduced or played on first end device 120 after the first candidate thumbnail image of the first section is selected by first end device 120. Further, apparatus 150 may determine whether the time amount for which the first section of the video content is reproduced on first end device 120 is greater than the predetermined amount of time. Apparatus 150 may increase the number of times of selections for the first candidate thumbnail image of the first section is selected, if the first section was played for three minutes which is greater than two minutes (i.e., the predetermined amount of time). The predetermined amount of time may be determined based on a total playing time of each of the sections of video content. For example, the predetermined amount of time may be half of a total playing time of each of the sections of the divided video content.

Further, the second section of video content may be displayed on second end device 130, since apparatus 150 streams, to second end device 130, the second section of the video content in which the selected first candidate thumbnail image is included when the first candidate thumbnail image of the second section is selected by second end device 130. Apparatus 150 may be configured to receive, from second end device 130, information regarding an amount of time for which the second section of the video content is reproduced or played on second end device 130 after the first candidate thumbnail image of the second section is selected by second end device 130. Further, apparatus 150 may determine whether the time amount for which the second section of the video content is reproduced or played on second end device 130 is greater than the predetermined amount of time. Apparatus 150 does not change or increase the number of times of selections for the first candidate thumbnail image of the second section is selected if the second section was played for one minute which is less than two minutes (i.e., the predetermined amount of time). Further, apparatus 150 may be configured to increase the display time period of the candidate thumbnail image as the number of times for the candidate thumbnail image causes the sections to be displayed for more than the predetermined amount of time increases. In accordance with the above example, apparatus 150 may be configured to increase the display time period of the first candidate thumbnail image of the first section of the video content, and to decrease the display time period of the second candidate thumbnail image of the first section of the video content because of the increase of the display time period of the first candidate thumbnail image of the first section.

Apparatus 150 may be configured to identify, from among the multiple candidate thumbnail images, the candidate thumbnail image that has a greatest display time period as a representative thumbnail image in each of the multiple sections. Further, apparatus 150 may be configured to transmit, to another end device, including first end device 120, second end device 130 and/or third end device 140, the video content and the representative thumbnail image of each of the multiple sections, when apparatus 150 receives a request for the video content from the other end device.

In some embodiments, apparatus 150 may be configured to transmit, to the other end device, an application that may enable the other end device to edit at least one of the video content or the representative thumbnail image in each of the sections. The other end device may be configured to select one or more of the representative thumbnail images, and to generate a user's own another video content (e.g., highlight video or preview video) that may include the selected representative thumbnail images by using the application.

Thus, FIG. 1 shows an example system 10 in which schemes for displaying video content may be implemented, in accordance with various embodiments described herein.

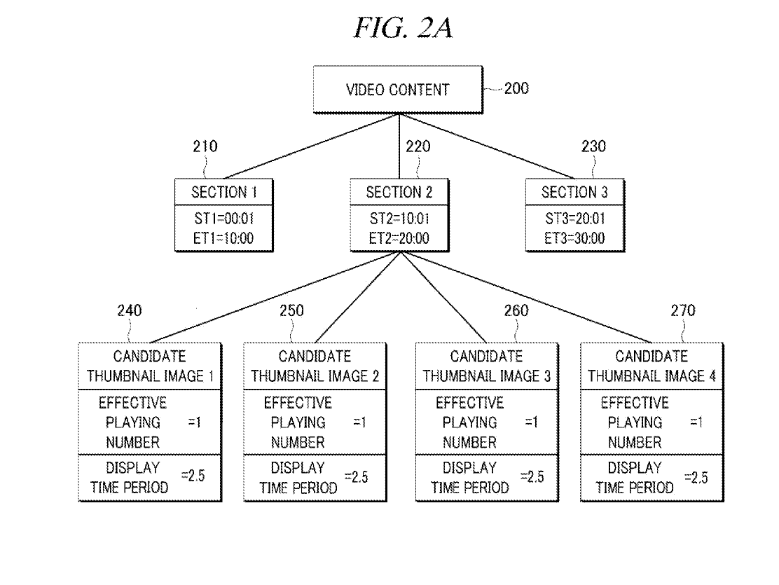

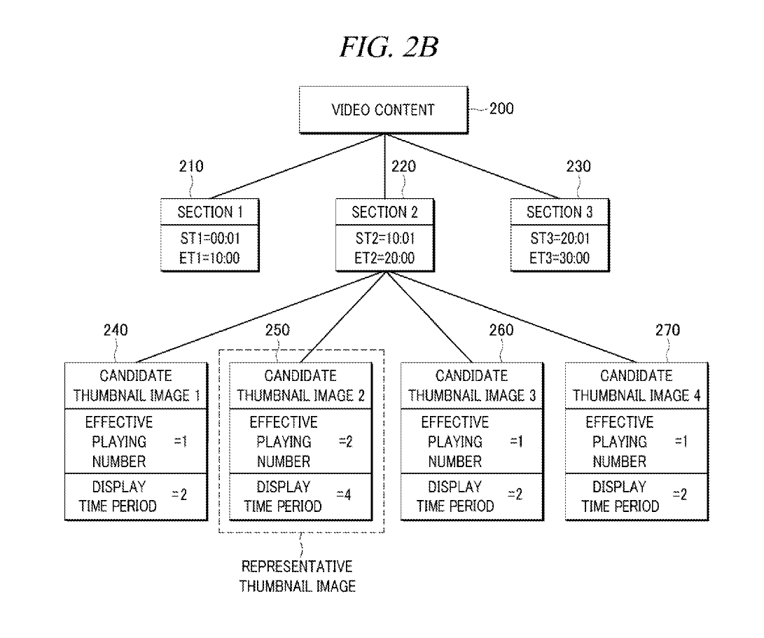

FIGS. 2A and 2B show illustrative example video content database of an apparatus by which at least portions of schemes for displaying video content may be implemented, in accordance with various embodiments described herein. FIG. 2A shows an initial state of the video content database. As depicted in FIG. 2A, for example, apparatus 150 may be configured to divide video content 200 into a first section 210, a second section 220, and a third section 230 automatically using known image analysis technologies. A starting time of first section 210 of the video content is 00:00 and an ending time of first section 210 of the video content is 10:00. Thus, a total playing time of first section 210 of the video content is ten minutes. A starting time of second section 220 of the video content is 10:01 and an ending time of second section 220 of the video content is 20:00. Thus, a total playing time of second section 220 of the video content is ten minutes. A starting time of third section 230 of the video content is 20:01 and an ending time of third section 230 of the video content is 30:00. Thus, a total playing time of third section 230 of the video content is ten minutes. The total playing time of first section 210, second section 220, and third section 230 of the video content is not limited to ten minutes.

Apparatus 150 may be further configured to determine and/or select multiple candidate thumbnail images in each of first section 210, second section 220, and third section 230 of the video content. For example, apparatus 150 may identify or recognize all images or frames that may constitute the video content using known image or frame recognition technologies, and to store the identified or recognized images or frames in a database. Further, apparatus 150 may determine and/or select one or more of the frames that are included in each section of the video content as the candidate thumbnail images from the database. For example, as depicted in FIG. 2A, apparatus 150 may select first candidate thumbnail image 240 of second section 220, second candidate thumbnail image 250 of second section 220, third candidate thumbnail image 260 of second section 220, and fourth candidate thumbnail image 270 of second section 220.

Each of first candidate thumbnail image 240, second candidate thumbnail image 250, third candidate thumbnail image 260, and fourth candidate thumbnail image 270 may have an initial effective playing number (e.g., one). As referenced herein, the effective playing number may be a number of times (or frequencies) for a candidate thumbnail image causes a section, in which the candidate thumbnail image is included, to be reproduced or played for more than a predetermined amount of time. The predetermined amount of time may be determined based on a total playing time of each section. For example, the predetermined amount of time may be half of a total playing time of each section. Further, each of first candidate thumbnail image 240, second candidate thumbnail image 250, third candidate thumbnail image 260, and fourth candidate thumbnail image 270 may have an initial display time period (e.g., 2.5 minutes). The display time period is a length of time, i.e., duration, for which a candidate thumbnail image to be displayed on an end device.

In some embodiments, apparatus 150 may be configured to receive, from one or more end devices (e.g., first end device 120, second end device 130, and third end device 140), a request for video content 200. Apparatus 150 may be configured to transmit, to one or more or first end device 120, second end device 130, and third end device 140, the multiple candidate thumbnail images of first section 210, second section 220 and third section 230 serially, along with video content 200 in response to the request. For example, apparatus 150 may transmit, to first end device 120, second end device 130, and third end device 140, first candidate thumbnail image 240 of second section 220, second candidate thumbnail image 250 of second section 220, third candidate thumbnail image 260 of second section 220, and fourth candidate thumbnail image 270 of second section 220 one by one. Each of first candidate thumbnail image 240 of second section 220, second candidate thumbnail image 250 of second section 220, third candidate thumbnail image 260 of second section 220, and fourth candidate thumbnail image 270 of second section 220 may be displayed on first end device 120, second end device 130, and third end device 140, alternatively at a time interval which is the same as the time interval of the display time period of first candidate thumbnail image 240, second candidate thumbnail image 250, third candidate thumbnail image 260, and fourth candidate thumbnail image 270 (e.g., 2.5 minutes interval). Accordingly, the displayed candidate thumbnail images of respective section of video content may be changed at the predetermined time interval (i.e., at the time interval of the display time period of each candidate thumbnail image).

Apparatus 150 may be configured to receive, from one or more of first end device 120, second end device 130, and third end device 140, user input to select various ones of the multiple candidate thumbnail images. For example, apparatus 150 may be configured to receive, from first end device 120, user input to select second candidate thumbnail image 250 of second section 220. Apparatus 150 may be configured to then stream, to first end device 120, second section 220 of video content 200.

Further, for the above example, apparatus 150 may be configured to receive, from first end device 120, information regarding an amount of time for which first section 220 of video content 200 is reproduced or played on first end device 120 after second candidate thumbnail image 250 of second section 220 is selected by first end device 120. Further, apparatus 150 may determine whether the time amount for which second section 220 of video content 200 is reproduced on first end device is greater than a predetermined amount of time. Apparatus 150 may increase the effective playing number for second candidate thumbnail image 250 of second section 220, if second section 220 of video content 200 was played for more than the predetermined amount of time.

Further, apparatus 150 may be configured to increase the display time period of second candidate thumbnail image 250 of second section 220, if the effective playing number for second candidate thumbnail image 250 of second section 220 increases. Thus, for example, as depicted in FIG. 2B, the effective playing number for second candidate thumbnail image 250 of second section 220 may be increased, and the display time period of second candidate thumbnail image 250 of second section 220 may be increased up to e.g., four minutes. Further, since the display time period of second candidate thumbnail image 250 of second section 220 increases, the others candidate thumbnail image of second section 220 (e.g., first candidate thumbnail image 240, third candidate thumbnail image 260, and fourth candidate thumbnail image 270) may be decreased.

Further, apparatus 150 may be configured to identify, from among multiple candidate thumbnail images, a candidate thumbnail image that has a greatest display time period as a representative thumbnail image in a section. For example, as depicted in FIG. 2B, apparatus 150 may determine a representative thumbnail image of second section 220 to be second candidate thumbnail image 250 of which the display time period is greater than those of first candidate thumbnail image 240, third candidate thumbnail image 260, and fourth candidate thumbnail image 270 of second section 220 of the video content.

Thus, FIGS. 2A and 2B show illustrative example video content database of an apparatus by which at least portions of schemes for displaying video content may be implemented, in accordance with various embodiments described herein.

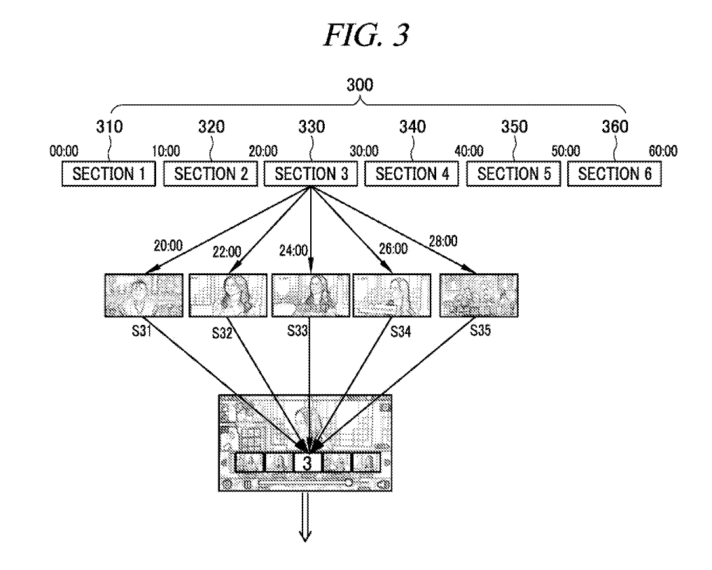

FIG. 3 shows an illustrative example of video content transmitted by an apparatus by which at least portions of schemes for displaying video content may be implemented, in accordance with various embodiments described herein. In some embodiments, apparatus 150 may be configured to divide video content 300 into a first section 310, a second section 320, a third section 330, a fourth section 340, a fifth section 350 and a sixth section 360, based on a playing time of each section automatically using known image or frame recognition technologies. For example, as depicted in FIG. 3, each of first section 310, second section 320, third section 330, fourth section 340, fifth section 350 and sixth section 360 may have equal or substantially equal time length (e.g., ten minutes).

Apparatus 150 may be further configured to determine multiple candidate thumbnail images in each of first section 310, second section 320, third section 330, fourth section 340, fifth section 350 and sixth section 360 of video content 300. For example, as depicted in FIG. 2A, apparatus 150 may select five candidate thumbnail images of third section 310 (e.g., a first candidate thumbnail image S31, a second candidate thumbnail image S32, a third candidate thumbnail image S33, a fourth candidate thumbnail image S34, and a fifth candidate thumbnail image S35). For example, apparatus 150 may determine and/or select one or more of frames that are included in each section of video content 300 as candidate thumbnail images from a database that already stores all images or frames that may constitute video content 300.

As depicted in FIG. 3B, first candidate thumbnail image S31 of third section 330 may be a frame that may correspond to a play time point of 20:00 of video content 300, second candidate thumbnail image S32 of third section 330 may be a frame that may correspond to a play time point of 22:00 of video content 300, third candidate thumbnail image S33 of third section 330 may be a frame that may correspond to a play time point of 24:00 of video content 300, fourth candidate thumbnail image S34 of third section 330 may be a frame that may correspond to a play time point of 26:00 of video content 300, and fifth candidate thumbnail image S35 of third section 330 may be a frame that may correspond to a play time point of 28:00 of video content 300. So, first candidate thumbnail image S31, second candidate thumbnail image S32, third candidate thumbnail image S33, fourth candidate thumbnail image S34, and fifth candidate thumbnail image S35 may have a same display time period (e.g., 2 minutes). The display time period is a length of time, i.e., duration, for which a candidate thumbnail image to be displayed on an end device.

Apparatus 150 may be further configured to receive, from an end device, a request for video content 300. Apparatus 150 may be further configured to transmit, to the end device, multiple candidate thumbnail images of first section 310, second section 320, third section 330, fourth section 340, fifth section 350 and sixth section 360 serially, along with video content 200. For example, apparatus 150 may transmit, to the end device, first candidate thumbnail image S31, second candidate thumbnail image S32, third candidate thumbnail image S33, fourth candidate thumbnail image S34, and fifth candidate thumbnail image S35 of third section 330 one by one. Thus, each of first candidate thumbnail image S31, second candidate thumbnail image S32, third candidate thumbnail image S33, fourth candidate thumbnail image S34, and fifth candidate thumbnail image S35 of third section 330 may be displayed on the end device, alternatively at a time interval which is the same as the display time period (e.g., 2 minutes interval). Accordingly, the displayed candidate thumbnail images of respective section of video content 300 may be changed at the time interval of the display time period of each candidate thumbnail image.

Thus, FIG. 3 shows an illustrative example of video content transmitted by an apparatus by which at least portions of schemes for displaying video content may be implemented, in accordance with various embodiments described herein.

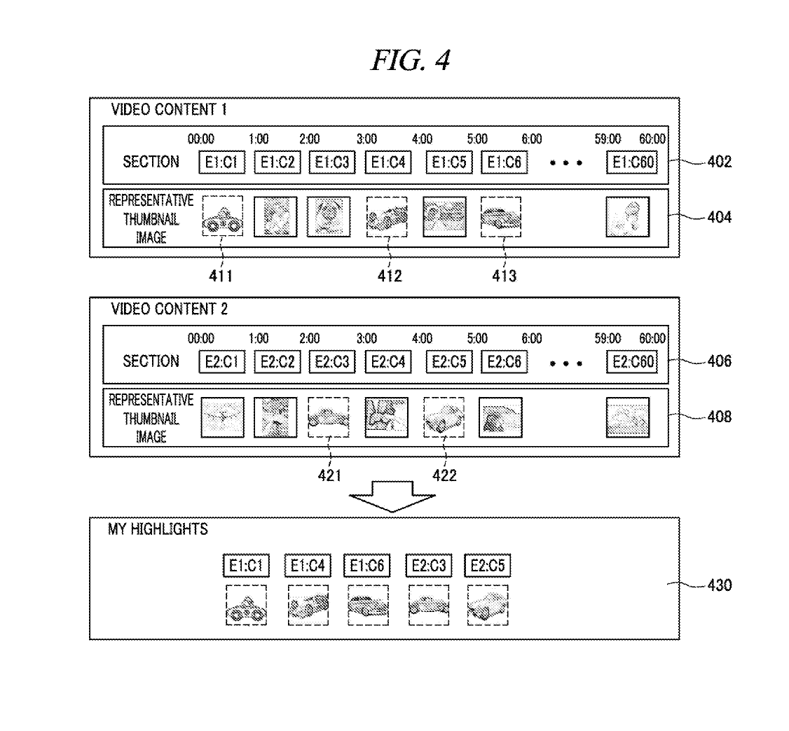

FIG. 4 shows an illustrative example of an application by which at least portions of schemes for displaying video content may be implemented, in accordance with various embodiments described herein. For example, as depicted in FIG. 4, apparatus 150 may be configured to divide first video content (e.g., video content 1) into multiple sections 402 (e.g., from a first section C1 of video content 1 to a sixty-th section C60 of video content 1) automatically using known image or frame recognition technologies. Further, apparatus 150 may determine and/or store representative thumbnail images 404 of each section (e.g., from first section C1 to sixty-th section C60) of the first video content.

Further, as depicted in FIG. 4, apparatus 150 may be configured to divide second video content (e.g., video content 2) into multiple sections 406 (e.g., from a first section C1 of video content 2 to a sixty-th section C60 of video content 2) automatically using known image or frame recognition technologies. Further, apparatus 150 may determine and/or store representative thumbnail images 408 of each section (e.g., from first section C1 to sixty-th section C60) of the second video content.

Further, in some embodiments, apparatus 150 may be configured to transmit, to one or more of first end device 120, second end device 130 and third end device 140, the first video content, second video content and representative thumbnail images 404 of the first video content, and representative thumbnail images 408 of the second video content when apparatus 150 receives a request for the first video content and second video content from one or more of first end device 120, second end device 130 and third end device 140.

Further, apparatus 105 may be configured to transmit, one or more of first end device 120, second end device 130 and third end device 140, an application that may enable to edit at least one of the first video content, the second video content, representative thumbnail images 404 of the first video content, or representative thumbnail images 408 of the second video content. For example, if the application is executed on an end device (e.g., first end device 120, second end device 130 or third end device 140), as depicted in FIG. 4, the end device may be configured to select a representative thumbnail image 411 of first section C1 of the first video content, a representative thumbnail image 412 of a fourth section C4 of the first video content, a representative thumbnail image 413 of sixth section C6 of the first video content, a representative thumbnail image 421 of third section C3 of the second video content, and a representative thumbnail image 422 of fifth section C5 of the second video content. Further, the end device may be configured to generate a highlight video content 430 that may include the selected multiple representative thumbnail images 411, 412, 413, 421 and 422 by executing the application using the transmitted application.

Thus, FIG. 4 shows an illustrative example of an application by which at least portions of schemes for displaying video content may be implemented, in accordance with various embodiments described herein.

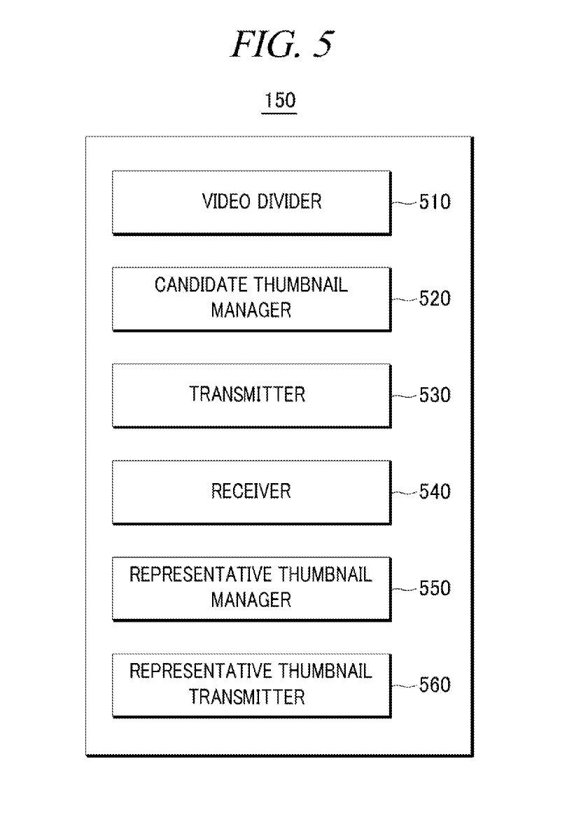

FIG. 5 shows an example apparatus 150 by which at least portions of schemes for displaying video content may be implemented, in accordance with various embodiments described herein. As depicted in FIG. 5, apparatus 150 may include a video divider 510, a candidate thumbnail manager 520, a transmitter 530, a receiver 540, a representative thumbnail manager 550 and a representative thumbnail transmitter 560. Although illustrated as discrete components, various components may be divided into additional components, combined into fewer components, or eliminated altogether while being contemplated within the scope of the disclosed subject matter. It will be understood by those skilled in the art that each function and/or operation of the components may be implemented, individually and/or collectively, by a wide range of hardware, software, firmware, or any combination thereof. In that regard, one or more of video divider 510, candidate thumbnail manager 520, transmitter 530, receiver 540, representative thumbnail manager 550 and representative thumbnail transmitter 560 may be included in an instance of an application hosted on apparatus 150.

Video divider 510 may be configured to divide video content into multiple sections. In some embodiments, video divider 510 may divide the video content into multiple sections based on at least one of pixel data or audio data of frames that may be included in each of the multiple sections automatically using known image analysis technologies or audio analysis/recognition technologies. For example, video divider 510 may analyze and/or obtain RGB values in each frame (e.g., from first frame to sixth frame) of the video content automatically using known image analysis technologies. Further, video divider 510 may identify or determine the first frame, second frame and third frame of the video content as a first section, and may identify or determine the fourth frame, fifth frame and sixth frame as a second section of the video content, if a difference between the RGB value of the third frame and the RGB value of the fourth frame is greater than a threshold value.

For another example, video divider 510 may be configured to analyze and/or obtain audio files that may be included in each frame (e.g., from first frame to sixth frame) of the video content automatically using known audio analysis technologies or audio recognition technologies. Further, video divider 510 may identify or determine the first frame, second frame and third frame as a first section, and the fourth frame, fifth frame and sixth frame as a second section, if a difference between a magnitude or a tone that corresponds to the third frame and a magnitude or a tone that corresponds to the fourth frame is greater than a threshold value.

In some embodiments, video divider 510 may be configured to divide the video content into the multiple sections, based on a playing time of each section automatically using known image or frame recognition technologies so as to determine a time length of each section of the video content. For example, the video content may be divided into multiple sections of equal or substantially equal time length.

Candidate thumbnail manager 520 may be configured to determine and/or select multiple candidate thumbnail images in each of the sections of the video content. For example, the candidate thumbnail image may be one of the frames which are included in the section of the video content. Images or frames that may constitute the video content may be stored in a database, and candidate thumbnail manager 520 may determine and/or select one or more of frames that are included in a section of the video content as the candidate thumbnail images of the section from the database. Further, each of the multiple candidate thumbnail images may have a display time period. The display time period refers to a length of time, i.e., duration, for which a candidate thumbnail image to be displayed on an end device. For example, an initial display time period of multiple candidate thumbnail images in a section of the video content may be the same.

Transmitter 530 may be configured to transmit, to one or more end devices (e.g., first end device 120, second end device 130, and third end device 140), the multiple candidate thumbnail images of each section, along with the video content. Transmitter 530 may transmit the multiple candidate thumbnail images of each section, serially. For example, transmitter 530 may transmit a first candidate thumbnail image of a first section and a first candidate thumbnail image of a second section for five minutes and thus, the first candidate thumbnail image of the first section of video content and the first candidate thumbnail image of the second section of video content may be displayed on one or more end devices for five minutes. Next, transmitter 530 may transmit a second candidate thumbnail image of the first section and a second candidate thumbnail image of the second section for five minutes after five minutes from the beginning of the transmission of the first candidate thumbnail image of the first section of video content and the first candidate thumbnail image of the second section of video content. Thus, the second candidate thumbnail image of the first section of video content and the second candidate thumbnail image of the second section of video content may be displayed on one or more end devices for five minutes. That is, transmitter 530 may be configured to transmit the multiple candidate thumbnail images of each section, one by one, at a predetermined time interval.

Further, transmitter 530 may be configured to change the display time period of the multiple candidate thumbnail images, based on user input to select various ones of the multiple candidate thumbnail images of the sections. For example, transmitter 530 may change the display time period of the multiple candidate thumbnail images, based on a number of times each of the multiple candidate thumbnail images is selected. For example, as a candidate thumbnail image is selected more by multiple end devices, the display time period of the candidate thumbnail image may increase.

For another example, transmitter 530 may be configured to change the display time period of the multiple candidate thumbnail images, based on a number of times each of the sections has been played or reproduced on end devices. Transmitter 530 may be configured to increase the number of times each of the sections has been played for a selected candidate thumbnail image of a section when the selected candidate thumbnail image causes the sections to be played for more than a predetermined amount of time. The predetermined amount of time may be determined based on a total playing time of the section of the video content. For example, the predetermined amount of time may be half of a total playing time of the section of the video content. Further, transmitter 530 may be configured to increase the display time period of the candidate thumbnail image as the number of times for the candidate thumbnail image causes the section, in which the candidate thumbnail image is included, to be displayed for more than the predetermined amount of time increases.

Receiver 540 may be configured to receive, from one or more end devices (e.g., first end device 120, second end device 130, and third end device 140), a request for the video content. Further, receiver 540 may be configured to receive, from one or more end devices (e.g., first end device 120, second end device 130, and third end device 140), user input to select various ones of the multiple candidate thumbnail images of each section of the video content.

Further, receiver 540 may be configured to receive, from one or more end devices (e.g., first end device 120, second end device 130, and third end device 140), information regarding an amount of time for which a section of the video content is reproduced or played on the end device after a candidate thumbnail image of the section is selected by each of the end devices.

Representative thumbnail manager 550 may be configured to identify a representative thumbnail image in each of the multiple sections, from among the multiple candidate thumbnail images, based on the user inputs. In some embodiments, representative thumbnail manager 550 may be configured to identify a representative thumbnail image, based on a number of times each of the multiple candidate thumbnail images is selected. Representative thumbnail manager 550 may determine a candidate thumbnail image that is selected the most by multiple end devices as a representative thumbnail image in a section. In some other embodiments, representative thumbnail manager 550 may be configured to determine a candidate thumbnail image that has a greatest display time period as a representative thumbnail image in a section. As described above, the display time period of a candidate thumbnail image may be changed based on the number of times for a section, in which the candidate thumbnail image is included, has been played when the candidate thumbnail image causes the section to be played for more than a predetermined amount of time.

Representative thumbnail transmitter 560 may be configured to transmit, to one or more end devices, the video content and the representative thumbnail image of each of the multiple sections.

In some embodiments, representative thumbnail transmitter 560 may be configured to transmit, to the one or more end devices, an application that may enable the end device to edit at least one of the video content or the representative thumbnail image in each of the sections. The end device may be configured to select one or more of the representative thumbnail images, and to generate a user's own video content (e.g., highlight video or preview video) that may include the selected representative thumbnail images by using the application upon executing the application on the end device.

Thus, FIG. 5 shows example apparatus 150 by which at least portions of schemes for displaying video content may be implemented, in accordance with various embodiments described herein.

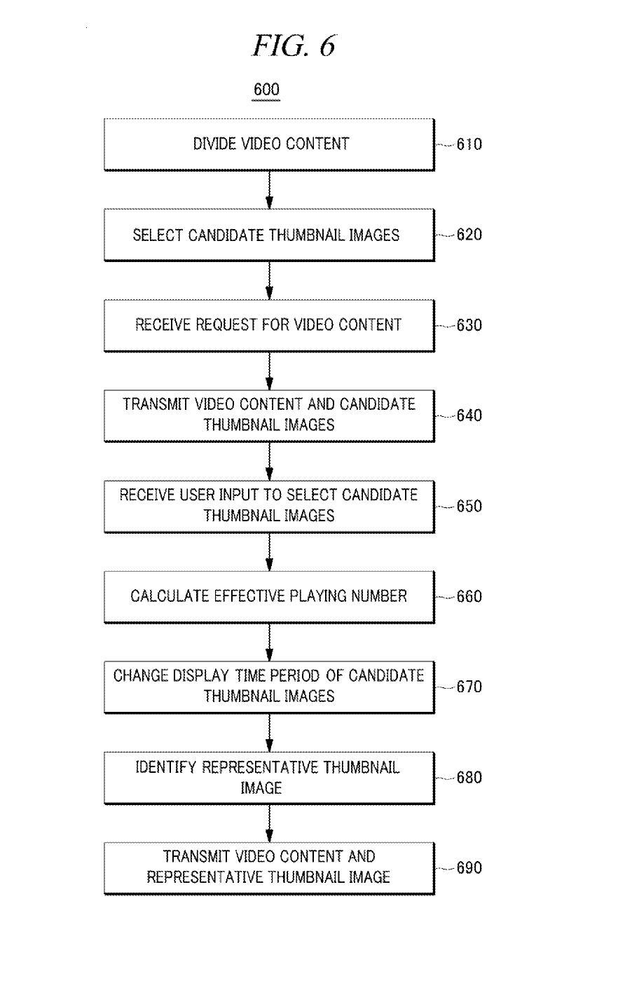

FIG. 6 shows an example processing flow 600 of operations by which at least portions of schemes for displaying video content may be implemented, in accordance with various embodiments described herein. The operations of processing flow 600 may be implemented in system configuration 10 including first end device 120, second end device 130, third end device 140, and apparatus 150, as illustrated in FIG. 1. Processing flow 600 may include one or more operations, actions, or functions as illustrated by one or more blocks 610, 620, 630, 640, 650, 660, 670, 680, and/or 690. Although illustrated as discrete blocks, various blocks may be divided into additional blocks, combined into fewer blocks, or eliminated, depending on the desired implementation. Processing may begin at block 610.

Block 610 (Divide Video Content) may refer to apparatus 150 dividing video content into multiple sections. In some embodiments, at block 610, apparatus 150 may divide the video content into multiple sections based on at least one of pixel data or audio data of frames that may be included in each of the multiple sections automatically using known image analysis technologies or audio analysis/recognition technologies. In some embodiments, at block 610, apparatus 150 may divide the video content into the multiple sections, based on a playing time of each section automatically using known image or frame recognition technologies so as to determine a time length of each section of the video content. For example, the video content may be divided into multiple sections of equal or substantially equal time length. Processing may proceed from block 610 to block 620.

Block 620 (Select Candidate Thumbnail Images) may refer to apparatus 150 selecting multiple candidate thumbnail images in each of the sections. For example, a thumbnail image may be an image or frame of the video content that are stored in a database. For example, apparatus 150 may identify or recognize all images or frames that may constitute the video content using known image or frame recognition technologies, and may store the identified or recognized images or frames in the database. At block 620, apparatus 150 may determine and/or select one or more of the frames that are included in a section of the video content as the candidate thumbnail images of the section from the database. Processing may proceed from block 620 to block 630.

Block 630 (Receive Request for Video Content) may refer to apparatus 150 receiving, from first end device 120, second end device 130, and/or third end device 140, a request for the video content. Processing may proceed from block 630 to block 640.

Block 640 (Transmit Video Content and Candidate Thumbnail Images) may refer to apparatus 150 transmitting, to first end device 120, second end device 130, and/or third end device 140, the video content and the multiple candidate thumbnail images of each section of the video content. Apparatus 150 may transmit the multiple candidate thumbnail images of each section, serially. For example, apparatus 150 may transmit the multiple candidate thumbnail images of each section, one by one, at a predetermined time interval, and thus, each of the multiple candidate thumbnail images of each section may be displayed on first end device 120, second end device 130, and/or third end device 140 at the predetermined time interval. Processing may proceed from block 640 to block 650.

Block 650 (Receive User Input to Select Candidate Thumbnail Images) may refer to apparatus 150 receiving, from first end device 120, second end device 130, and/or third end device 140, user input to select various ones of the multiple candidate thumbnail images of each section of the video content. At block 650, one or more of first end device 120, second end device 130, and/or third end device 140 may transmit, to apparatus 150, user input to select at least one candidate thumbnail image from among the multiple candidate thumbnail images. Then, a section of the video content, in which the selected candidate thumbnail image is included, may be transmitted to one or more of first end device 120, second end device 130, and/or third end device 140 in response to the user input, and may be reproduced or played on one or more of first end device 120, second end device 130, and/or third end device 140. Processing may proceed from block 650 to block 660.

Block 660 (Calculate Effective Playing Number) may refer to apparatus 150 calculating effective playing number of the multiple candidate thumbnail images. The effective playing number may be a number of times for a candidate thumbnail image causes a section, in which the candidate thumbnail image is included, to be played or reproduced for more than a predetermined amount of time. At block 660, apparatus 150 may receive, from first end device 120, second end device 130, and/or third end device 140, information regarding an amount of time for which a section of the video content has been reproduced or played on first end device 120, second end device 130, and/or third end device 140 after a candidate thumbnail image that is included in the section is selected at block 650. At block 660, apparatus 150 may further determine whether the time amount for which the section of the video content is reproduced on first end device 120, second end device 130, and/or third end device 140 is greater than a predetermined amount of time. Apparatus 150 may increase the effective playing number for the candidate thumbnail image of the section, if the section of the video content was played for more than the predetermined amount of time. Processing may proceed from block 660 to block 670.

Block 670 (Change Display Time Period of Candidate Thumbnail Images) may refer to apparatus 150 changing a display time period of the multiple candidate thumbnail images, based on the effective playing number for the multiple candidate thumbnail images. In some embodiments, at block 670, apparatus 150 may increase the display time period of the candidate thumbnail image of the section, if the effective playing number for the candidate thumbnail image increased at block 660. Processing may proceed from block 670 to block 680.

Block 680 (Identify Representative Thumbnail Image) may refer to apparatus 150 identifying a representative thumbnail image in each of the multiple sections, from among the multiple candidate thumbnail images, based on the display time period of the multiple candidate thumbnail images. In some embodiments, apparatus 150 may determine a candidate thumbnail image that has a greatest display time period as a representative thumbnail image in a section of the video content. Processing may proceed from block 680 to block 690.

Block 690 (Transmit Video Content and Representative Thumbnail Image) may refer to apparatus 150 transmitting, to one or more end devices, the video content and the representative thumbnail image of each of the multiple sections of the video content. Thus, the video content and the representative thumbnail images may be played or reproduced on the one or more end devices.

Thus, FIG. 6 shows an example processing flow 600 of operations by which at least portions of schemes for displaying video content may be implemented, in accordance with various embodiments described herein.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

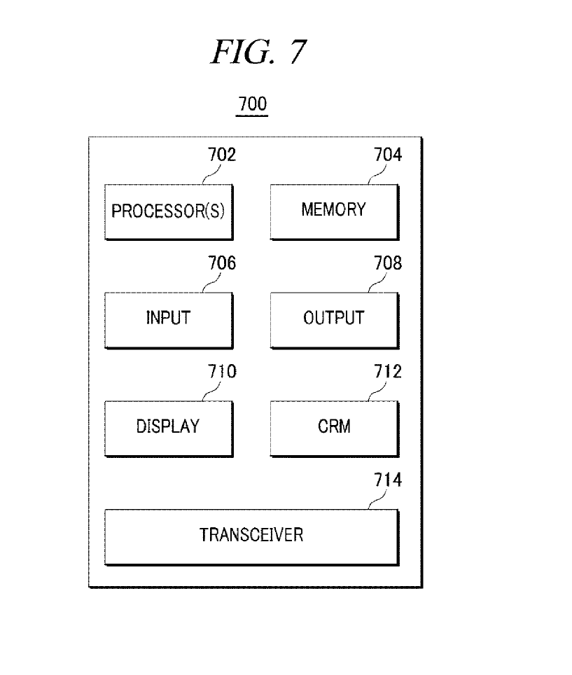

FIG. 7 shows an illustrative computing embodiment, in which any of the processes and sub-processes of schemes for displaying video content may be implemented as computer-readable instructions stored on a computer-readable medium, in accordance with various embodiments described herein. The computer-readable instructions may, for example, be executed by a processor of a device, as referenced herein, having a network element and/or any other device corresponding thereto, particularly as applicable to the applications and/or programs described above corresponding to the configuration 10 for transactional permissions.

In a very basic configuration, a computing device 700 may typically include, at least, one or more processors 702, a system memory 704, one or more input components 706, one or more output components 708, a display component 710, a computer-readable medium 712, and a transceiver 714.

Processor 702 may refer to, e.g., a microprocessor, a microcontroller, a digital signal processor, or any combination thereof.

Memory 704 may refer to, e.g., a volatile memory, non-volatile memory, or any combination thereof. Memory 704 may store, therein, an operating system, an application, and/or program data. That is, memory 704 may store executable instructions to implement any of the functions or operations described above and, therefore, memory 704 may be regarded as a computer-readable medium.

Input component 706 may refer to a built-in or communicatively coupled keyboard, touch screen, or telecommunication device. Alternatively, input component 706 may include a microphone that is configured, in cooperation with a voice-recognition program that may be stored in memory 704, to receive voice commands from a user of computing device 700. Further, input component 706, if not built-in to computing device 700, may be communicatively coupled thereto via short-range communication protocols including, but not limitation, radio frequency or Bluetooth.

Output component 708 may refer to a component or module, built-in or removable from computing device 700, that is configured to output commands and data to an external device.

Display component 710 may refer to, e.g., a solid state display that may have touch input capabilities. That is, display component 710 may include capabilities that may be shared with or replace those of input component 706.

Computer-readable medium 712 may refer to a separable machine readable medium that is configured to store one or more programs that embody any of the functions or operations described above. That is, computer-readable medium 712, which may be received into or otherwise connected to a drive component of computing device 700, may store executable instructions to implement any of the functions or operations described above. These instructions may be complimentary or otherwise independent of those stored by memory 704.

Transceiver 714 may refer to a network communication link for computing device 700, configured as a wired network or direct-wired connection. Alternatively, transceiver 714 may be configured as a wireless connection, e.g., radio frequency (RF), infrared, Bluetooth, and other wireless protocols.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

We claim:

1. A method performed under control of an apparatus, comprising:
dividing video content into a plurality of sections;
selecting a plurality of candidate thumbnail images in each of the sections;
transmitting, to a plurality of end devices, the plurality of candidate thumbnail images serially, along with the video content;
receiving, from the plurality of end devices, user input to select various ones of the plurality of candidate thumbnail images; and
changing a display time period of the plurality of candidate thumbnail images, based on the received user input.

2. The method of claim 1, further comprising:
identifying, from among the plurality of candidate thumbnail images, the candidate thumbnail image that has a greatest display time period as a representative thumbnail image in each of the sections; and
transmitting, to another end device, the video content and the representative thumbnail image.

3. The method of claim 2, further comprising:
transmitting, to the other end device, an application configured to edit at least one of the video content or the representative thumbnail image in each of the sections.

4. The method of claim 1, wherein the changing of the display time period of the plurality of candidate thumbnail images is based on a number of times each of the sections has been played, and
wherein the number increases for the selected candidate thumbnail image when the selected candidate thumbnail image causes the sections to be played for more than a predetermined amount of time.

5. The method of claim 4, wherein the predetermined amount of time is determined based on a total playing time of each of the sections.

6. The method of claim 1, wherein the changing of the display time period of the plurality of candidate thumbnail images is based on a number of times each of the plurality of candidate thumbnail images is selected.

7. The method of claim 1, wherein each of the plurality of sections includes one or more frames, and
wherein the dividing of the video content into the plurality of sections is based on at least one of pixel data or audio data of the one or more frames.

8. An apparatus, comprising:
a video divider configured to divide video content into a plurality of sections;
a candidate thumbnail manager configured to determine a plurality of candidate thumbnail images in each of the sections;
a transmitter configured to transmit, to a plurality of end devices, the plurality of candidate thumbnail images serially, along with the video content;
a receiver configured to receive, from the plurality of end devices, user input to select various ones of the plurality of candidate thumbnail images; and
a representative thumbnail manager configured to identify a representative thumbnail image in each of the sections from among the plurality of candidate thumbnail images, based on the user input.

9. The device of claim 8, wherein the transmitter is further configured to change a display time period of the plurality of candidate thumbnail images, based on the user inputs.

10. The device of claim 8, wherein the transmitter is further configured to increase a number of times each of the sections has been played for the selected candidate thumbnail image when the selected candidate thumbnail image causes the sections to be played for more than a predetermined amount of time, and
wherein the representative thumbnail manager is configured to identify the representative thumbnail image based on the number of times each of the sections has been played.

11. The device of claim 10, wherein the predetermined amount of time is determined based on a total playing time of each of the sections.

12. The device of claim 8, wherein the representative thumbnail manager is configured to identify the representative thumbnail image, based on a number of times each of the plurality of candidate thumbnail images is selected.

13. The device of claim 8, wherein each of the plurality of sections includes one or more frames, and
wherein the section divider is configured to divide the video content into the plurality of sections, based on at least one of pixel data or audio data of the one or more frames.

14. The device of claim 8, further comprising:
a representative thumbnail transmitter configured to transmit, to another end device, an application configured to edit at least one of the video content or the representative thumbnail image in each of the sections.

15. A system, comprising:
a video playing device configured to:
play video content,
display serially, a plurality of candidate thumbnail images in each of multiple sections that constitute the video content, and
transmit user input to select at least one candidate thumbnail image from among the plurality of candidate thumbnail images; and
a video manager configured to:
divide the video content into the multiple sections,
select the plurality of candidate thumbnail images in each of the multiple sections,
transmit, to the video playing device, the plurality of candidate thumbnail images serially, along with the video content, and
change a display time period of the plurality of candidate thumbnail images, based on the user input.

16. The system of claim 15, wherein the video playing device is further configured to:
play a section that includes the selected candidate thumbnail image from among the multiple sections, upon receiving the user input, and
transmit, to the video manager, time information that indicates playing time during which the section has been played.

17. The system of claim 15, wherein the video manager is further configured to identify the candidate thumbnail image that has a greatest display time period as a representative thumbnail image in each of the sections, and
wherein the video manager is further configured to transmit, to another device, the video content and the representative thumbnail image in each of the multiple sections.

18. The system of claim 17, wherein the video manager is further configured to transmit, to another device, an application configured to edit at least one of the video content or the representative thumbnail image in each of the multiple sections.

19. The system of claim 15, wherein each of the multiple sections includes one or more frames, and
wherein the video manager is configured to divide the video content into the multiple of sections, based on at least one of pixel data or audio data of the one or more frames.

20. The system of claim 15, wherein the video manager is configured to change the display time period of the plurality of candidate thumbnail images, based on a number of times each of the at least one candidate thumbnail image is selected.
